(19) United States
(12) Patent Application Publication
(10) Pub. No.: US 2013/0063973 A1
(43) Pub. Date: Mar. 14, 2013

(54) LIGHTING FIXTURES HAVING OBSERVABLE ILLUMINATED SPECKLED PATTERN

(71) Applicant: Peter H. MAHOWALD, Los Altos, CA (US)

(72) Inventor: Peter H. MAHOWALD, Los Altos, CA (US)

(21) Appl. No.: 13/229,173

(22) Filed: Sep. 9, 2011

(51) Int. Cl. F21V 8/00; F21V 5/04

(52) U.S. Cl. 362/608; 362/612; 362/613

(57) ABSTRACT

A lighting fixture includes at least one optic and at least one coherent light source for directing at least one substantially coherent light beam towards the at least one optic. Light provided from the at least one optic comprises an observable illuminated speckle patterned surface resulting from the coherent light beam.

### FIELD OF THE INVENTION

This invention relates generally to luminaires or lighting fixtures, and more specifically, to luminaires or lighting fixtures employing a coherent light beam to produce an observable speckle pattern.

### BACKGROUND OF THE INVENTION

For decades, typically luminaires are composed of incandescent or fluorescent technology. Recent attempts have been made to provide luminaires which incorporate LEDs (light emitting diodes).

Recent attempts at luminaires employing LEDs include employing a plurality of LED emitting incoherent light that is directed into a light guide from which the light is desirably uniformly emitted uniformly from a surface of the light guide.

There is a need for further luminaires or lighting fixtures, and more specifically, to luminaires or lighting fixtures incorporating a laser to provide an observable speckle pattern.

### SUMMARY OF THE INVENTION

In a first aspect, the present invention provides a lighting fixture having at least one optic, at least one coherent light source operable to produce at least one substantially coherent light beam directable towards the at least one optic, and wherein the at least one optic comprises an observable illuminated speckle patterned surface resulting from the coherent light beam.

In a second aspect, the present invention provides a lighting fixture having at least one optic, at least one incoherent light source operable to produce incoherent light directable towards the at least one optic, and at least one coherent light source operable to produce at least one substantially coherent light beam directable towards the at least one optic. The at least one optic comprises an observable illuminated speckle patterned surface resulting from the coherent light beam and an observable illuminated non-speckle patterned surface resulting from the incoherent light.

In a third aspect, the present invention provides a lighting fixture having at least one light guide, a plurality of light-emitting diodes operable to produce incoherent light inwardly directable towards an edge of the at least one light guide, and at least one laser operable to produce at least one substantially coherent light beam directable inwardly towards an edge of the at least one light guide. The at least one light guide comprises an observable illuminated speckle patterned surface resulting from the coherent light beam and an observable illuminated non-speckle patterned surface resulting from the incoherent light.

In a fourth aspect, the present invention provides a method for providing illumination. The method includes providing at least one substantially coherent light beam, introducing the incoherent light into an optic, and emitting an observable illuminated speckle patterned surface resulting from the coherent light beam from a surface of the optic.

In a fifth aspect, the present invention provides a method for providing illumination. The method includes providing incoherent light, providing at least one substantially coherent light beam, introducing the incoherent light and the at least one substantially coherent light beam into an optic, emitting light from the optic to provide an observable illuminated speckle patterned surface resulting from the coherent light beam and an observable illuminated non-speckle patterned surface resulting from the incoherent light.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a perspective view of one embodiment of a lighting fixture for providing an observable illuminated speckled pattern and an observable illuminated non-speckled pattern in accordance with an aspect of the present invention;

FIG. 2 is a partial cross-sectional view of the lighting fixture of FIG. 1;

FIG. 3 is an exploded perspective view of a portion of the lighting fixture of FIG. 1;

FIG. 4 is an enlarged perspective view of the portion of the lighting fixture of FIG. 3;

FIG. 5 is a perspective view of a portion of another embodiment of a lighting fixture in accordance with an aspect of the present invention;

FIG. 6 is a perspective view of a cylindrical lens for dispersing laser light for use in the lighting fixture of FIG. 1;

FIG. 7 is a side elevational view of a portion of another embodiment of a lighting fixture in accordance with an aspect of the present invention;

FIG. 8 is a perspective view of an actuator and laser for moving a coherent light beam for use in the lighting fixture of FIG. 1;

FIG. 9 is a perspective view of another embodiment of a lighting fixture for providing an observable illuminated speckled pattern and an observable illuminated non-speckled pattern in accordance with an aspect of the present invention;

FIG. 10 is a view of one embodiment of an illuminated surface in connection with an aspect of the present invention;

FIG. 11 is a perspective view of another embodiment of a lighting fixture for providing an observable illuminated speckled pattern and an observable illuminated non-speckled pattern in accordance with an aspect of the present invention; and

FIG. 12 is a diagrammatic diagram of a processor and sensor for controlling the light illuminated from a lighting fixture in accordance with an aspect of the present invention.

### DETAILED DESCRIPTION OF THE INVENTION

The present invention, in one aspect, provides visual interest in a luminaire or lighting fixture by adding laser light which may be provided by adding a low cost laser and modulating electrical or mechanical system. In addition, the luminaire or lighting fixture may provide added visual interest or “energy” sensation via speckle, speckle movement as well as a higher color rendition index. As described below, coherent light such as laser light may be made to travel via a variety of optical paths to the observer's eye and interferes constructively or destructively to create speckle. Drive current modulation or mechanical structure modulation can change the path lengths and therefore the observed position of the speckle.

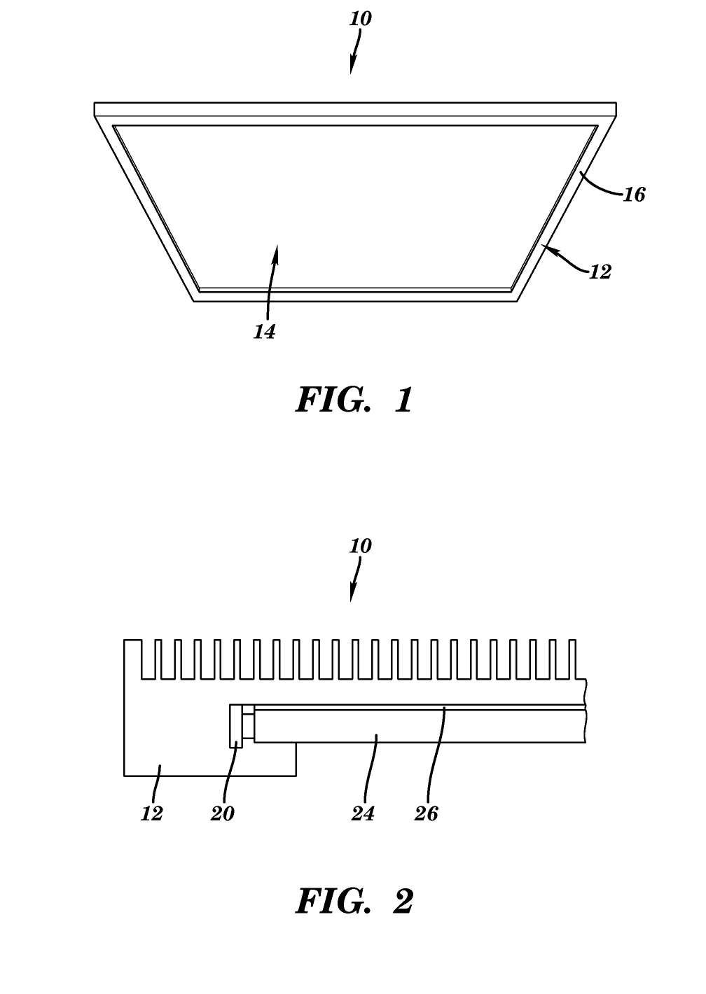

FIG. 1 illustrates one embodiment of a lighting fixture system 10 employing, for example, laser assisted illumination in accordance with an aspect of the present invention. In this exemplary embodiment, lighting fixture system 10 may include a peripheral frame 12 defining a primary lighting opening 14 which is bounded by a front surface 16 of frame 12. As described in greater detail below, the frame may surround an optic or light guide to guide light produced by one or more LEDs and one or more lasers to provide illumination through the primary lighting opening and/or provide illumination through a secondary lighting opening (not shown) on the other side of the frame. For example, the lighting fixture system may be suspended or supported form above, such as from a ceiling of a room, and configured to provide accent illumination and/or illumination for use to view other objects by the light reflected from those objects such as the general lighting found in most rooms.

FIG. 2 illustrates a partial cross-sectional view of lighting fixture 10. In this exemplary embodiment, one or more optical elements may be bound by frame 12. For example, light may be emitted from a light source 20 such as at least one light emitting diode (LED) and at least one laser into an optic 24 such as a light guide. Light may be prohibited from exiting the top of the fixture by a reflector 26 and redirected into optic 24 and the light observable by an observer from below.

The light guide may be formed from a material such as glass or plastic such as an acrylic material, e.g., static free acrylic such as PLEXIGLASS. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. In some embodiments, the reflector may include a plurality of opening such as holes to allow some of the light in the light guide to exit towards the top of the light fixture.

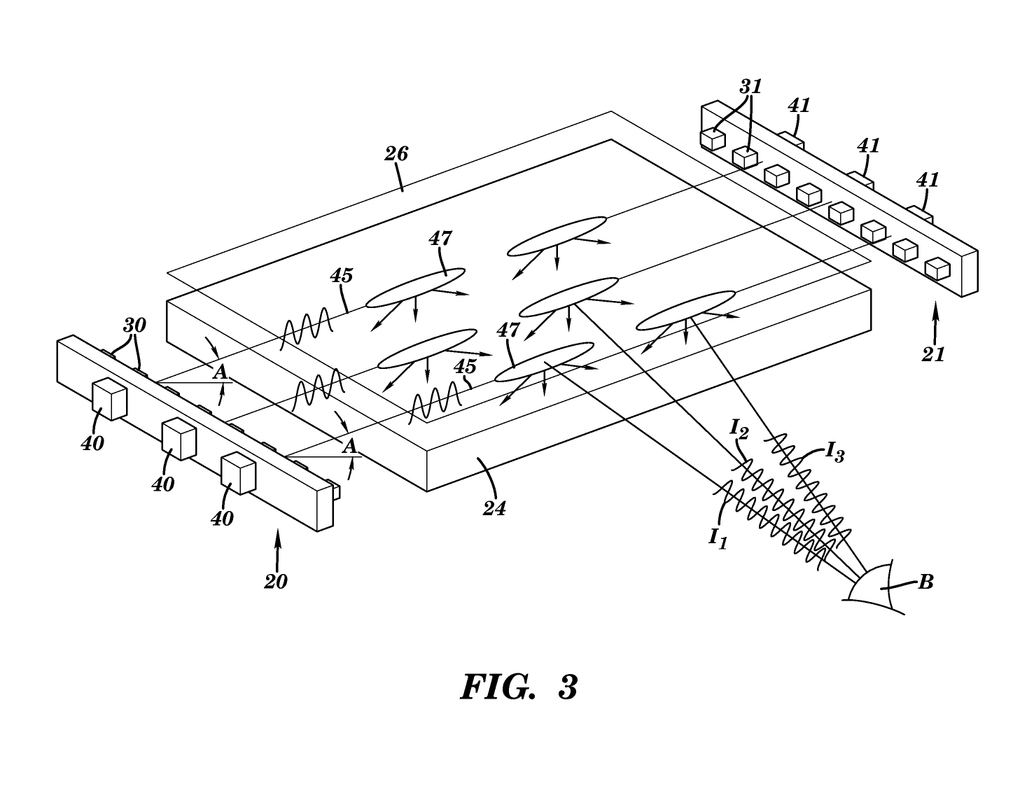

FIG. 3 enlarged perspective view of a portion of lighting fixture 10 (FIG. 1). For example, light source 20 may be disposed along one side of optic 24 and may include a plurality of LEDs 30 and a plurality of lasers 40 which project light into optic 24. A second light source 21 may be disposed along an opposite side of optic 24 and may include a plurality of LEDs 31 and a plurality of lasers 41 which project light into optic 24. Light may be prohibited from exiting the top of the fixture by reflector 26 and redirected back into optic 24 and the light observable by an observer from below.

For example, the lasers (light amplification by stimulated emission of radiation) may be electronic-optical devices that emit coherent radiation. As a light source, the laser may have various properties. For example, the laser may emit light in a narrow, low-divergence beam and with a well-defined wavelength which may correspond to a particular color if the laser operates in the visible spectrum. By contrast, the LEDs may emit light or incoherent radiation into a large solid angle and over a larger spectrum of wavelengths.

The laser may consist of a “gain medium” inside an optical cavity, with a means to supply energy to the gain medium. The gain medium may be a material (gas, liquid, solid, or free electrons) with appropriate optical properties. In its simplest form, the cavity may consist of two mirrors arranged such that light bounces back and forth, each time passing through the gain medium. Typically, one of the two mirrors, the “output coupler,” is partially transparent. Light of a specific wavelength that passes through the gain medium is amplified. The output laser beam is emitted through this mirror. The process of supplying the energy required for the amplification is called “pumping,” and the energy is typically supplied as an electrical current or as light at a different wavelength. A suitable laser for use in the present invention may be Orion HV Series, model no. 625 nm available from Laserglow Technologies.

With reference still to FIG. 3, the narrow coherent beams 45 of radiation emitted from the laser are reflected off reflective surface 26 resulting in the lighting fixture surface having a visual appearance of an observable illuminated speckle pattern 47, e.g., when observed by an observer from below. The wider incoherent light emitted from the LEDs may result in a more uniformly and evenly distributed light emitted from the lighting fixture when viewed from below. The laser light results in the lighting fixture having additional visual interest. It will be appreciated that the reflective surface may reflect substantially all the light impinging on the reflective surface or an opaque cover may be disposed over the reflective surface so that light is observable only from below. In addition, the reflective surface may permit some of the light to be emitted through the reflected surface such as upwardly form the lighting fixture and other of the light to be reflected from the reflective surface such as downwardly from the lighting fixture.

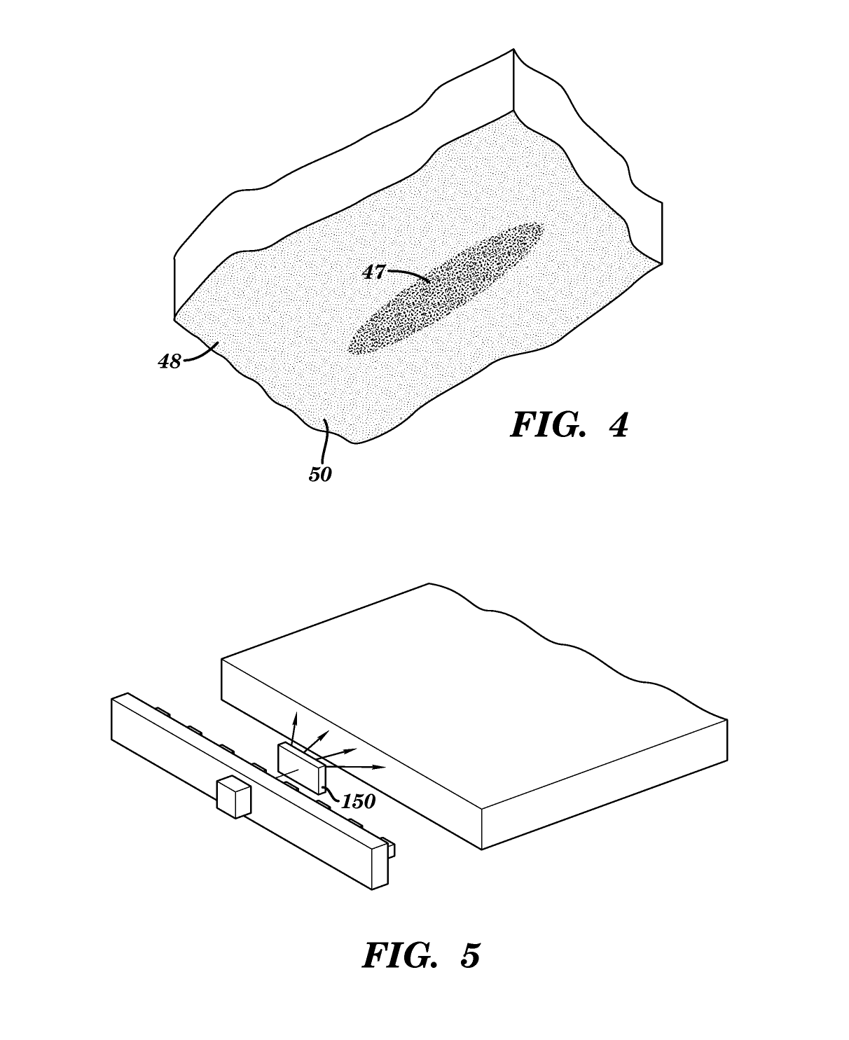

FIG. 4 illustrates an enlarged view of a portion, for example, a bottom portion of the lighting fixture, illustrating a surface 50 having an observable illuminated speckle pattern 47 and observable illuminated non-speckle pattern 48 such as a uniform non-speckle pattern. The surface may be the bottom surface of the optic, the reflective surface, or any other surface of the lighting fixture.

For example, speckle is a grainy glistening not present in normal light that provides the feeling of “energy” and visual interest to the appearance of the lighting fixture. The grainy speckle pattern moves with the observer, while the rest of the lighting fixture and its light appear stationary. The speckle is caused by the coherence of the laser beam, and the constructive and destructive interference that depends on relative path lengths and therefore the phase of multiple paths to the observer. The illuminated space below the lighting fixture may not be affected by the speckling effect and may affect an incidental increase in the color rendition index and quality of the color of the light emitted from the lighting fixture.

With reference again to FIG. 3, the beam may be incident on optic 24 such as a translucent light guide, at a glancing angle A, spreading its light over a larger distance than the diameter of the beam. A plurality of lasers or laser optical paths may be employed. The speckled pattern may be oval as shown in FIGS. 3 and 4, or may have other configurations such as lines, circular, spots, etc., and other designs as described below. In addition, by positioning the plurality of lasers or laser optical paths at an angle relative to each other, a cross-hatched pattern or appearance may be produced.

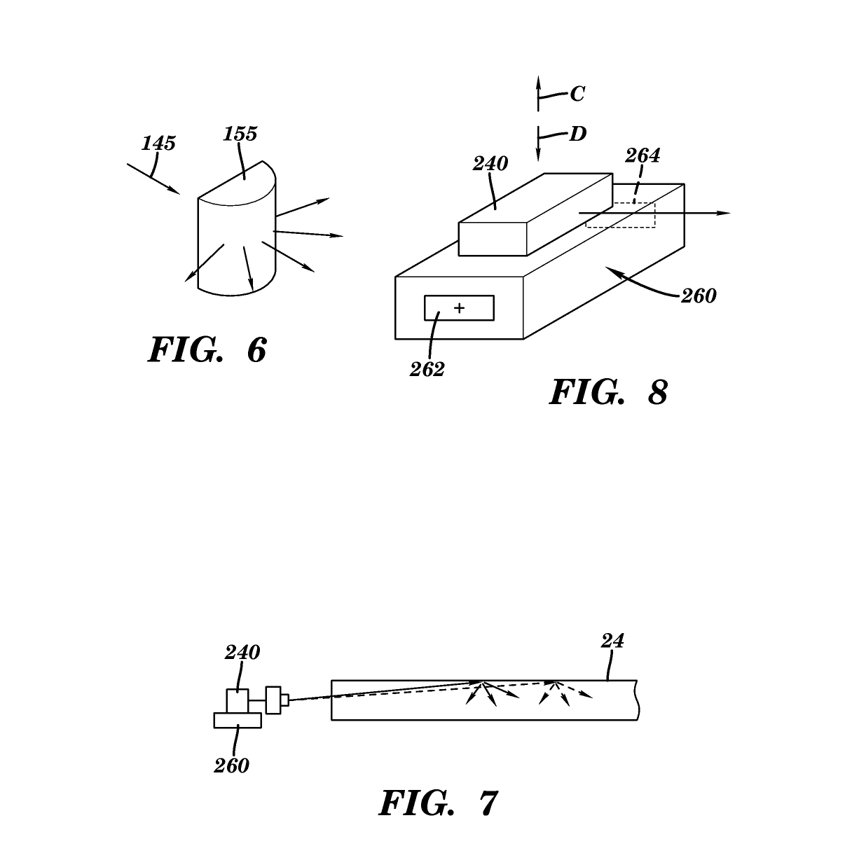

With reference to FIG. 5, in another embodiment of a lighting fixture in accordance with the present invention, a diffuser 150 may be used to spread the light beam emitted from the laser prior to the coherent light entering the light guide. The resulting lighting fixture may spread out or provide a uniform glistening of, for example, red or green speckle, to the lit surfaces or volumes of the lighting fixture. FIG. 6 illustrates one embodiment of a cylindrical lens 155 for diffusing laser light beam 145 for use in the lighting fixtures of the present invention. Other suitable lenses may include aspherical lenses. The lens may be a separate component or integrated with the light guide.

With reference again to FIG. 3, speckle is created in an observer's eye B (retina). The speckle pattern is sensitive to the path length from the laser to the retina. The laser speckle has the unusual effect that it seems to move with the observer. When the observer moves, the path lengths from different parts of the lighting fixture are different, and the speckle pattern appears to move. In addition to the notion of “energy”, this provides a sense of user-centeredness that some people find endearing.

FIG. 7 is an illustration of another embodiment of a portion of a lighting fixture in accordance with an aspect of the present invention. For example, it is also possible to modulate the speckle by moving the laser. Little mechanical movement is required as the path length needs to change, for example, only by a fraction of a wavelength to provide some sense of movement of the speckle. For example, a laser 240 disposed on and moved using a piezoelectric crystal 260 may change position of the laser without drawing much power. A piezoelectric crystal material generates a voltage when mechanical pressure is applied and conversely undergoes mechanical stress (operable to move the laser) when subjected to a voltage. As shown in FIG. 8, applying a positive charge to a positive electrode 262, and a negative charge to a negative electrode 264 on piezoelectric crystal 260 may be operable to cause laser 240 to move, for example, in the direction of arrow C when the charge is applied, and in the direction of arrow D when the applied voltage is removed. Different shaped piezoelectric crystal may result in different movement of the laser for a given applied voltage potential. Other devices for moving the laser or redirecting the light beam may include MEMS (microelectromechanical systems), DLP (digital light processing) technology, and other suitable technologies. The variations may be slow as to indicate cloud movement, or fast, or even moving with the sound of music into an electromagnetic linear motor such as a speaker voice coil.

In another embodiment, it may be possible to modulate the speckle by varying the drive current to the laser. For example, a controller or processor may be coupled to the laser to control the current to the laser, and thus, the direction of the coherent beam.

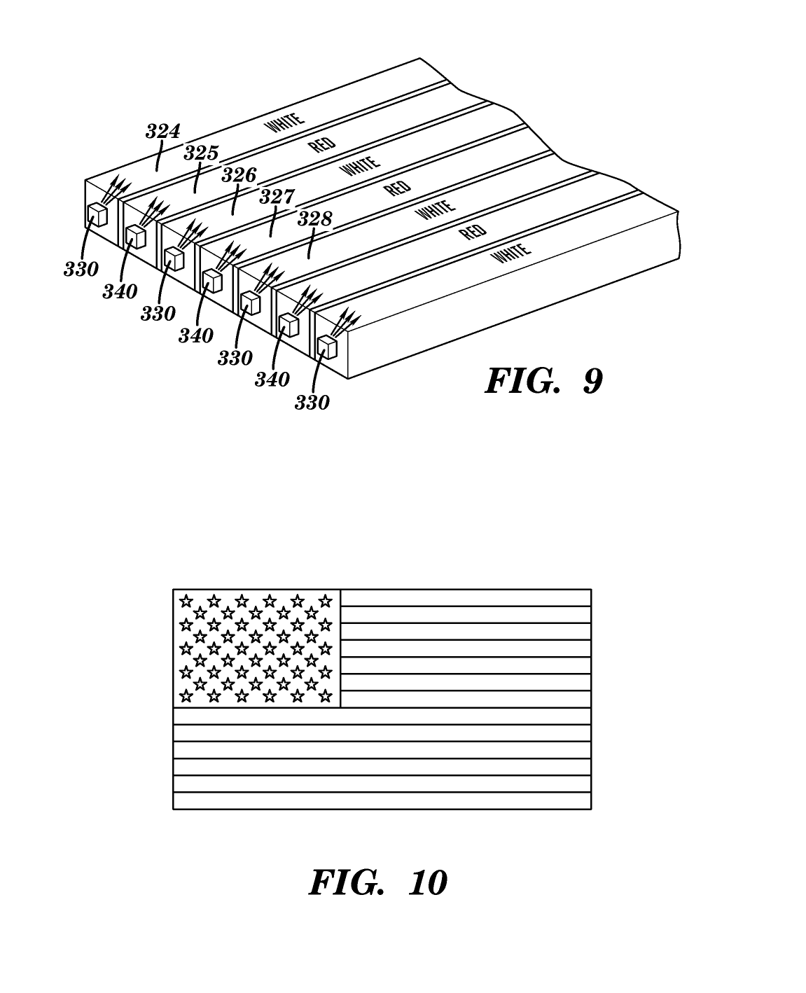

FIG. 9 illustrates another embodiment of a portion of a lighting fixture in accordance with an aspect of the present invention. For example, a lighting fixture may include embedded or separate light guides 324, 326, and 328 for separately transmitting light from LEDs 330 and embedded or separate light guides 325 and 327 for separately transmitting light from lasers 340. Between the separate light guides may be an air gap, different dielectric material, or materials having indices of refraction different than the light guides. A single light guide may be thermally treated to define the separate light guides. The upper face of the light guides may include a reflector such as a white or silver reflector. The reflector may be an aluminum coated MYLAR material. Various designs may be configured employing lighting fixtures having various light guides such as a representation of an American flag as shown in FIG. 10.

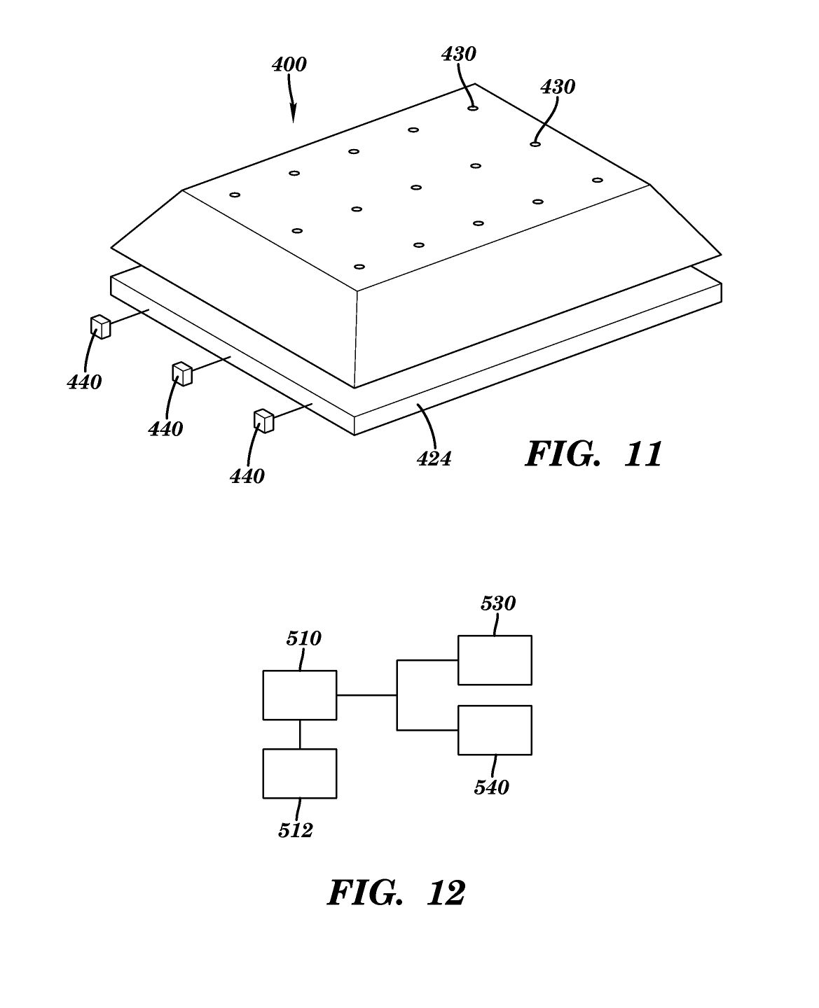

With reference to FIG. 11, in another embodiment, a lighting fixture 400 may include a plurality of LEDs 430 disposed above an upper surface of a light guide 424, and a plurality of lasers 440 disposed along an edge of the light guide. For example, the light guide may be a transparent planar material or a translucent diffuser. In one embodiment, a diffusing layer (not shown) may be disposed along the top of the light guide. The main white lighting may come from the LEDs above the diffuser and the laser light may come laterally in clear light pipes in the diffuser panel. Significant optical power may be needed for the red or green laser light. Multiple lasers may be needed, or a separate light path (with less diffuser) may be needed to bring this light efficiently out. Light guides embedded in the diffuser may be advantageous for this purpose.

In some implementations it may be desirable to use a sensor to balance the white LED light with the laser light brightness. For example, as shown in FIG. 12, an optical sensor 512 may be employed to detect the white and/or the laser light. A processor 510 may receive signals from sensor 512 to adjust either the laser light beam from a laser 540 or white light brightness from one or more LEDs 430 to control the degree of speckle. In another aspect, the relative strength of the white and the laser light may be measured to control the amount of speckle as the laser and LEDs degrade.

Due to the increased red and/or green light being emitted from the lighting fixture, it can be advantageous to move the phosphor emission of the LED from yellow to green. This helps balance the color of the lighting to include the color of the red laser without moving the color temperature of the light.

It is also possible to use green or UV laser(s) which impinge on phosphors, or e.g. quantum dots. The speckle occurs in the UV and with path lengths that are very nearly equal the speckle will be long enough period for the speckle to become visible on the surface of the phosphor.

While red or green lasers may be employed, other color lasers will also be suitable. The lighting fixtures of the present invention may be installed in lobbies, retail, offices, commercial and industrial spaces, and residential spaces for general illumination.

Thus, while various embodiments of the present invention have been illustrated and described, it will be appreciated to those skilled in the art that many changes and modifications may be made thereunto without departing from the spirit and scope of the invention.

1. A lighting fixture comprising:
at least one optic;
at least one coherent light source operable to produce at least one substantially coherent light beam directable towards said at least one optic; and
wherein said at least one optic comprises an observable illuminated speckle patterned surface resulting from said coherent light beam.

2. The lighting fixture of claim 1 wherein said observable illuminated speckle patterned surface comprises a first observable illuminated speckled pattern observable at a first location and a different second observable illuminated speckled pattern observable at a second location.

3. The lighting fixture of claim 1 wherein said observable illuminated speckle patterned surface comprises varying intensities.

4. The lighting fixture of claim 1 further comprising an actuator operable to move said at least one coherent light source to change said observable illuminated speckle patterned surface.

5. The lighting fixture of claim 1 wherein said optic comprises at least one light guide, and said coherent light source comprises at least one laser operable to produce said at least one substantially coherent light beam directable inwardly towards an edge of said at least one light guide.

6. The lighting fixture of claim 5 further comprising:
a peripheral frame disposed around said at least one light guide and said at least one laser, said peripheral frame defining an opening bounded by outside surfaces of a front side of said peripheral frame; and
wherein said observable illuminated speckle patterned surface is disposed between said opening in said peripheral frame.

7. A lighting fixture comprising:
at least one optic;
at least one incoherent light source operable to produce incoherent light directable towards said at least one optic;
at least one coherent light source operable to produce at least one substantially coherent light beam directable towards said at least one optic; and
wherein said at least one optic comprises an observable illuminated speckle patterned surface resulting from said coherent light beam and an observable illuminated non-speckle patterned surface resulting from said incoherent light.

8. The lighting fixture of claim 7 wherein said observable illuminated speckle patterned surface comprises a first observable illuminated speckled pattern observable at a first location and a different second observable illuminated speckled pattern observable at a second location.

9. The lighting fixture of claim 7 wherein said at least one substantially coherent light beam is directed at a glancing angle greater than 0-degrees relative to a surface of said optic.

10. The lighting fixture of claim 7 wherein said observable illuminated speckle patterned surface comprises a generally oval shape.

11. The lighting fixture of claim 7 further comprising an actuator operable to move said at least one coherent light source to change said observable illuminated speckle patterned surface.

12. The lighting fixture of claim 7 wherein said actuator comprises a piezoelectric material.

13. The lighting fixture of claim 7 wherein said at least one coherent light source comprises at least one laser.

14. The lighting fixture of claim 13 wherein said at least one laser comprises at least one of a red laser and a green laser.

15. The lighting fixture of claim 7 wherein said at least one incoherent light source comprises at least one light emitting diode.

16. The lighting fixture of claim 15 wherein at least one light emitting diode comprises at least one white light emitting diode.

17. The lighting fixture of claim 7 wherein said optic comprises a light guide, and said observable illuminated speckle patterned surface and said observable illuminated non-speckle patterned surface comprise a surface of said light guide.

18. The lighting fixture of claim 7 wherein said observable illuminated non-speckled pattern resulting from said incoherent light comprises a generally uniform observable illuminated non-speckled pattern.

19. The lighting fixture of claim 7 wherein said observable illuminated speckled pattern and said observable illuminated non-speckled pattern are commingled.

20. The lighting fixture of claim 7 further comprising a diffuser, and wherein said coherent light is directable through said diffuser.

21. The lighting fixture of claim 7 further comprising a lens, and wherein said coherent light is directable through said lens.

22. The lighting fixture of claim 7 further comprising a sensor operable for use in balancing the brightness of the coherent light and incoherent light.

23. A lighting fixture comprising:
at least one light guide;
a plurality of light-emitting diodes operable to produce incoherent light inwardly directable towards an edge of said at least one light guide;
at least one laser operable to produce at least one substantially coherent light beam directable inwardly towards an edge of said at least one light guide; and
wherein said at least one light guide comprises an observable illuminated speckle patterned surface resulting from said coherent light beam and an observable illuminated non-speckle patterned surface resulting from said incoherent light.

24. The lighting fixture of claim 23 further comprising:
a peripheral frame disposed around said at least one light guide, said plurality of light-emitting diodes, and said at least one laser, said peripheral frame defining an opening bounded by outside surfaces of a front side of said peripheral frame; and
wherein said observable illuminated speckle patterned surface is disposed between said opening in said peripheral frame and said observable illuminated non-speckle patterned surface is disposed between said opening in said peripheral frame.

25. The lighting fixture of claim 23 wherein said observable illuminated speckled pattern comprises a first observable illuminated speckled pattern observable at a first location and a different second observable illuminated speckled pattern observable at a second location.

26. The lighting fixture of claim 23 wherein said at least one substantially coherent light beam is directed at a glancing angle greater than 0-degrees relative to a surface of said light guide.

27. The lighting fixture of claim 23 further comprising an actuator operable to move said at least one coherent light source to change said observable illuminated speckled pattern.

28. The lighting fixture of claim 23 wherein said actuator comprises a piezoelectric material.

29. The lighting fixture of claim 23 wherein said at least one laser comprises at least one of a red laser and a green laser, and said at least one light emitting diode comprises at least one white light emitting diode.

30. The lighting fixture of claim 23 wherein said observable illuminated non-speckled pattern resulting from said incoherent light comprises a generally uniform observable illuminated non-speckled pattern.

31. The lighting fixture of claim 23 wherein said observable illuminated speckled pattern and said observable illuminated non-speckled pattern are commingled.

32. The lighting fixture of claim 23 further comprising a diffuser, and wherein said coherent light is directable through said diffuser.

33. The lighting fixture of claim 23 further comprising a lens, and wherein said coherent light is directable through said lens.

34. The lighting fixture of claim 23 further comprising a sensor operable for use in balancing the brightness of the coherent light and incoherent light.

35. A method for providing illumination, the method comprising:
providing at least one substantially coherent light beam;
introducing the incoherent light into an optic; and
emitting an observable illuminated speckle patterned surface resulting from the coherent light beam from a surface of the optic.

36. The method of claim 35 wherein the observable illuminated speckled pattern comprises a first observable illuminated speckled pattern observable at a first location and a different second observable illuminated speckled pattern observable at a second location.

37. The method of claim 35 wherein the observable illuminated speckle patterned surface comprises varying intensities.

38. The method of claim 35 further comprising moving the at least one coherent light beam for changing the observable illuminated speckled pattern.

39. A method for providing illumination, the method comprising:
providing incoherent light;
providing at least one substantially coherent light beam;
introducing the incoherent light and the at least one substantially coherent light beam into an optic; and
emitting light from the optic to provide an observable illuminated speckle patterned surface resulting from the coherent light beam and an observable illuminated non-speckle patterned surface resulting from the incoherent light.

40. The method of claim 39 wherein the observable illuminated speckled pattern comprises a first observable illuminated speckled pattern observable at a first location and a different second observable illuminated speckled pattern observable at a second location.

41. The method of claim 39 wherein the introducing the at least one substantially coherent light beam comprises introducing the at least one substantially coherent light beam a glancing angle greater than 0-degrees relative to a surface of the optic.

42. The method of claim 39 further comprising moving the at least one coherent light beam for changing the observable illuminated speckled pattern.

43. The method of claim 39 wherein the emitting light comprises emitting the observable illuminated non-speckled pattern comprising a generally uniform observable illuminated non-speckled pattern.

44. The method of claim 39 wherein the providing at least one substantially coherent light beam comprises passing the at least one substantially coherent light beam through a diffuser.

45. The method of claim 39 wherein the providing at least one substantially coherent light beam comprises passing the at least one substantially coherent light beam through a lens.

46. The method of claim 39 wherein the emitting light comprises commingling the observable illuminated speckled pattern resulting from the coherent light beam with the observable illuminated non-speckled pattern resulting from the incoherent light.

47. The method of claim 39 further comprising adjusting the brightness of the coherent light relative to the incoherent light.

48. The method of claim 39 wherein:
the providing incoherent light comprises providing a plurality of light-emitting diodes;
the providing at least one substantially coherent light beam comprises providing at least one laser;
the introducing the incoherent light and the at least one substantially coherent light beam into an optic comprises introducing the incoherent light and the at least one substantially coherent light beam into an edge of at least one light guide; and
the emitting light comprises emitting light to provide the observable illuminated speckled pattern on a surface of the light guide resulting from the coherent light beam and the observable illuminated non-speckled pattern on the surface of the light guide resulting from the incoherent light.

49. The method of claim 48 further comprising
providing a peripheral frame disposed around the at least one light guide, the plurality of light-emitting diodes, and the at least one laser; and
the emitting light comprises emitting the light through an opening in the peripheral frame comprising the observable illuminated speckled pattern resulting from the coherent light beam and the observable illuminated non-speckled pattern resulting from the incoherent light.

50. The method of claim 49 wherein the observable illuminated speckled pattern comprises a first observable illuminated speckled pattern observable at a first location and a different second observable illuminated speckled pattern observable at a second location.

51. The method of claim 49 further comprising moving the at least one coherent light beam for changing the observable illuminated speckled pattern.

52. The method of claim 49 wherein the observable illuminated non-speckled pattern resulting from the incoherent light comprises a generally uniform observable illuminated non-speckled pattern.

53. The method of claim 49 wherein the emitting light comprises emitting the light through the opening in the peripheral frame comprising the observable illuminated speckled pattern resulting from the coherent light beam commingled with the observable illuminated non-speckled pattern resulting from the incoherent light.

54. The method of claim 49 further comprising adjusting the brightness of the coherent light relative to the incoherent light.
